(19) United States
(12) Patent Application Publication
(10) Pub. No.: US 2026/0160170 A1
(43) Pub. Date: Jun. 11, 2026

(54) METHOD FOR MANUFACTURING A METAL PROTECTION DEVICE FOR THE LEADING EDGE OF A BLADE INCORPORATING A DE-ICING SYSTEM AND PROTECTION DEVICE OBTAINED BY THIS METHOD

(71) Applicant: SAFRAN, PARIS (FR)

(72) Inventors: Jean-Michel Patrick Maurice FRANCHET, MOISSY CRAMAYEL (FR); Thierry Claude Henri GODON, MOISSY CRAMAYEL (FR); Jérôme HOBIER, MOISSY CRAMAYEL (FR)

(21) Appl. No.: 18/708,074

(22) PCT Filed: Nov. 4, 2022
(86) PCT No.: PCT/FR2022/052084

§ 371 Date: May 7, 2024

(30) Foreign Application Priority Data
Nov. 10, 2021 (FR) FR2111930

(51) Int. Cl. F01D 5/28; F01D 5/18; F01D 25/02; H05B 3/56

(52) U.S. Cl. CPC F01D 5/282; F01D 5/18; F01D 25/02; H05B 3/56; F05D 2220/36; F05D 2230/10; F05D 2230/233; F05D 2230/235; F05D 2230/236; F05D 2240/303; H05B 2214/02

(57) ABSTRACT

A method for manufacturing a metal protection device for a leading edge of a blade made of composite material for a turbojet engine, includes the operations of: a) shaping a pressure-side sheet and a suction-side sheet and machining at least one groove suitable for receiving a resistive element, b) producing a core having a shape identical to the shape of the leading edge of the blade, c) positioning the core between the pressure-side sheet and suction-side sheet and positioning the resistive element in the groove, d) evacuating and closing the assembly by welding, e) assembling the assembly by hot isostatic pressing, f) cutting the assembly and extracting the core, g) final machining to obtain a protection device with a predefined profile.

### TECHNICAL FIELD OF THE INVENTION

The present invention relates to a method for manufacturing a metal protection device for the leading edge of a compressor blade made of composite material for an aeronautical machine, this protection device integrating a de-icing system. The invention also relates to a metal protection device obtained by this method.

The invention finds applications in the field of protection of rotating pieces of aeronautical machines. In particular, it finds applications in the field of protection of turbofan compressor blades against ice.

### TECHNOLOGICAL BACKGROUND OF THE INVENTION

In aeronautics, rotating machines are constantly developed to become more and more efficient. The turbofan engine is part of these developments. In this type of turbofan engine, thrust is obtained by ejecting both hot gases and a flow of cold air. Indeed, air entering frontwardly of the turbofan is divided into two parts which follow two distinct paths before meeting at the outlet: the primary flow which enters the core of the engine where it is heated before being ejected, and the secondary flow which is diverted to the periphery of the core. A turbofan engine is therefore characterised by its bypass ratio, i.e. the ratio of the mass of the secondary flow to that of the primary flow.

Driven by changes in environmental standards, new aeroplane engine architectures are being contemplated. All these new designs provide a significant increase in the bypass ratio, which leads to very large fan, or fan module, dimensions. These new architectures include a reduction gearbox to limit fan rotation speeds so as to maintain acceptable speeds at the top of the fan blades (in the order of Mach 1). These so-called ‘slow’ fans, due to the low rotation speed of the fan blades and the immobility of the outlet guide blades, are subject to ice accretion on said fan blades and OGVs. This ice accretion, or accumulation, gives rise to several drawbacks, including:
unbalance caused by the mass of ice on the fan blades,
a deterioration in the aerodynamic performance of the fan and the OGV by impairment of the aerodynamic surfaces, and/or
damage (to the engine downstream or to the aeroplane) caused by the release of the ice projectile.

Consequently, in order to avoid ice accretion, new engine architectures seek to protect the fan blades and OGVs of the engine against ice accumulation.

Currently, two types of protection against icing of turbojet engine pieces are known:
anti-icing protection, which prevents any ice accretion on the pieces. This type of ice protection uses so-called ‘icephobic’ coatings, which are still at an early stage of development; and
protection by defrosting, which makes it possible to limit the mass of ice accreted on the pieces so that said mass of ice is detached in small quantities by centrifugal force during engine rotation.

Two types of de-icing protection techniques have been developed to date. One consists of supplying hot air taken from further downstream in the engine and reinjected via channels into the parts to be de-iced. Not only is this technique complex to implement, but it also has a direct impact on engine efficiency because part of the hot flow is diverted for de-icing and is no longer found in the form of thrust in the primary flow. The other of these techniques consists in using an electrothermal heater, of the heater mat type, one example of which is represented in FIGS. 1A and 1B. This heater mat 40 can be positioned either outside the fan blade 10 or the OGV, as represented in FIG. 1A, or between the composite material part 30 of the fan blade or the OGV and a metal protection device 20 of the leading edge of said blade or said OGV, as represented in FIG. 1B.

It is remembered that, for reasons of weight and cost, fan blades and OGVs 10 of turbofans are often made mainly of composite material. However, these fan blades and OGVs-subsequently generalised under the term ‘blades’—are subject to significant mechanical stresses due to their rotation speed and the aerodynamic load they support. These blades should also be able to withstand impact of particles or foreign bodies that would enter the machine's airflow. It is therefore necessary to protect at least part of these composite material blades. Generally, the protection is located at the leading edge of the composite material blade 30. For this, this leading edge is covered with a metal piece, called a protection device 20, which wraps around the end of said blade. One example of such a metal protection device 20 is represented in FIG. 2, in exploded view, with the leading edge 30 of the composite material blade. When the metal protection device 20 is mounted around the leading edge 30 of the composite material blade, said leading edge is protected from most mechanical stresses and impacts by said protection device 20.

In the de-icing technique using electrothermal heating, when said electrothermal heating is positioned outside of the blade 10, i.e. when the heater mat 40 covers the external surface of the blade 10, the erosion resistance of the blade is provided by an anti-abrasion elastomer film. In this configuration, ice protection has a first negative effect on the aerodynamic and aeroacoustic performance of the blade, especially as a result of the increased thickness of its leading edge, and a second negative effect on the shape tolerance of the leading edge after installation of the heater mat (wedging, skewing, etc.). When the heater mat 40 is positioned between the composite material blade 30 and the metal protection device 20, the heater mat 40 should be thin and installed deep into the protection device 20. Installation of the heater mat 40 is therefore delicate and difficult to implement. In addition, it is not possible to completely de-ice the nose 15 of the blade 10, i.e. the tip of the protection device 20, which cannot be covered due to overall space constraints.

There is therefore a real need for an ice protection device which is effective and easy to implement within a fan blade or an OGV.

### SUMMARY OF THE INVENTION

In order to respond to the above discussed problems of effectiveness and ease of implementation of an electrothermal heater, the applicant provides a metal protection device for the leading edge of a blade made of composite material, integrating an electrothermal heater in the form of a resistive element. The applicant also provides a method for manufacturing this protection device.

According to a first aspect, the invention relates to a method for manufacturing a metal protection device for a leading edge of a blade made of composite material for a turbofan, including the operations of:
a) shaping, by die forging, a lower face sheet and an upper face sheet,
b) making a core having a shape identical to the shape of the leading edge of the blade,
c) positioning the core between the lower surface and upper surface sheets,
d) vacuumising and closing the assembly by welding,
e) assembling the assembly by hot isostatic pressing,
f) cutting the assembly and extracting the core,
g) final machining to obtain a protection device with a predefined profile.

This manufacturing method is characterised in that, on the one hand, operation a) includes machining, on an inner face of at least one of the lower surface and upper surface sheets, at least one groove adapted to receive a resistive element and, on the other hand, operation c) includes positioning a resistive element in the groove, the resistive element forming an electrothermal heater integrated into the metal protection device of the leading edge of the blade.

The term ‘resistive’ will be interpreted, in the description and the claims, in its electrical sense, as an electrical resistance element generating energy in the form of heat.

This method has the advantage of being relatively simple to implement since it partially uses a manufacturing method already implemented for the manufacture of metal protection devices for composite material blades or OGVs. It also has the advantage of ensuring proper heat distribution along the leading edge of the blade.

In addition to the characteristics just discussed in the preceding paragraph, the manufacturing method according to one aspect of the invention may have one or several complementary characteristics from among the following, considered individually or according to any technically possible combinations:
operation a) includes machining of an array of grooves including an even number of grooves.
the groove is machined in a welding zone of the lower surface or upper surface sheet, over at least part of the width of the protection device.
the resistive element is a heating cable including at least one thermally conductive wire of metal, housed in an insulating sheath.
the thermally conductive wire is made of a nickel-chromium alloy.
the insulating sheath is made of a substantially inert material having a melting point above 1050° C. and no phase change in the interval from 20° C. to 1050° C. and having a thermal expansion close to that of a material from which the lower surface and upper surface sheets are formed.
the insulating sheath is at least partially made of a corrosion-resistant material.
the corrosion-resistant material is a titanium alloy or stainless steel.
the heating cable includes a layer of magnesium oxide placed between the thermally conductive wire and the insulating sheath.

According to a second aspect, the invention relates to a metal protection device for a leading edge of a composite material blade for a turbofan, characterised in that it includes:
an upper surface sheet and a lower surface sheet assembled together and forming an inner cavity adapted to wrap the leading edge of the blade, and
a resistive element integrated into an inner face of at least one of the lower surface and upper surface sheets.

This protection device has the advantage of integrating the de-icing system within the device so that the heat source for this system is internal. This avoids the risk of heat loss which generally occurs when the systems are assembled together. The fact that the de-icing system is internal to the protection device also means that the aerodynamics of the piece remain intact.

Advantageously, the protection device is obtained by the method as previously defined.

Advantageously, the resistive element is housed in a contact zone between the lower surface metal sheet and the upper surface metal sheet, in a tip of said protection device.

Advantageously, the protection device includes one or several of the characteristics mentioned above for the method, such as the fact that the resistive element is housed in a groove machined in the welding zone of the lower surface and upper surface sheet, that the resistive element is a heating cable including at least one thermally conductive wire made of metal, housed in an insulating sheath, that the thermally conductive wire is made of a nickel-chromium alloy, that the insulating sheath is at least partially made of a corrosion-resistant material, that the corrosion-resistant material is a titanium alloy or stainless steel, that the heating cable includes a layer of magnesium oxide placed between the thermally conductive wire and the insulating sheath and/or that the insulating sheath is made of a substantially inert material having a melting point above 1050° C. and no phase change in a range between 20° C. and 1050° C. and having a thermal expansion close to a material in which the lower surface and upper surface sheets are formed.

According to a third aspect, the invention relates to a turbofan blade, wherein the blade includes a composite material leading edge and a metal protection device wrapping said leading edge, characterised in that the protection device includes a tip in which a resistive element is housed, said resistive element extending along the composite material leading edge.

According to a fourth aspect, the invention relates to a turbofan, characterised in that it includes a plurality of blades as defined above.

### BRIEF DESCRIPTION OF THE FIGURES

Further advantages and characteristics of the invention will become apparent from the following description, illustrated by the figures in which:

FIGS. 1A and 1B, already described, represent cross-sectional views of two modes of installing a heater mat in a turbofan blade, according to the state of the art;

FIG. 2, already described, represents a cross-sectional view of a metal protection device for a composite material blade according to the state of the art;

FIG. 3 represents a schematic cross-sectional view of a metal protection device according to the invention;

FIG. 4 represents, in the form of a functional diagram, different operations of the method for manufacturing the metal protection device according to the invention;

FIG. 5 schematically represents perspective views of the various pieces used in manufacturing the metal protection device of FIG. 3; and

FIG. 6 represents a schematic cross-sectional view of the compacted assembly obtained during the method of FIG. 4 with the pieces of FIG. 5.

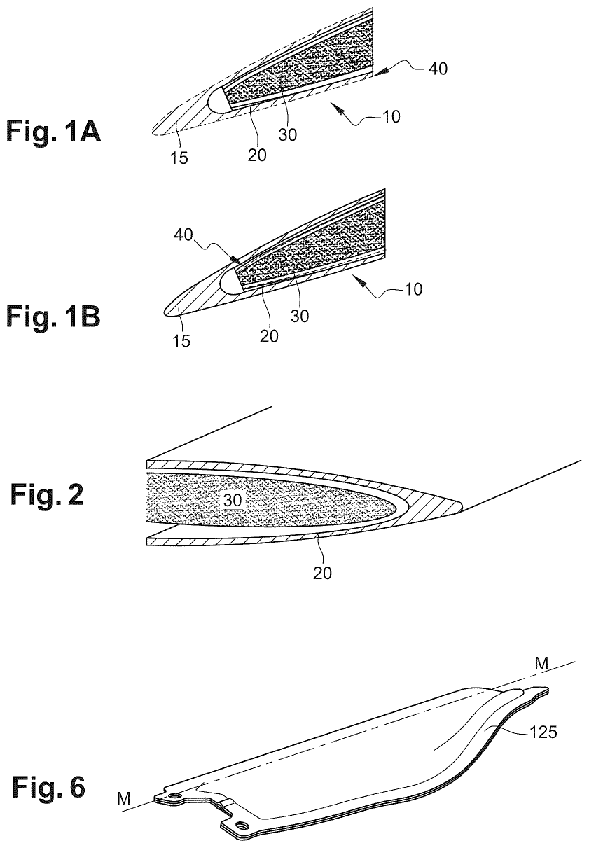

### DETAILED DESCRIPTION

One example of making a metal protection device for the leading edge of a composite material blade, integrating a de-icing system, is described in detail below, with reference to the appended drawings. This example illustrates the characteristics and advantages of the invention. It should be reminded, however, that the invention is not limited to this example.

In the figures, identical elements are marked with identical references. For reasons of legibility, size scales between the elements represented are not respected. The description will be given in a general way for a ‘blade’, it being understood that this blade may be a fan blade, an OGV or any other turbofan piece requiring metal protection and de-icing.

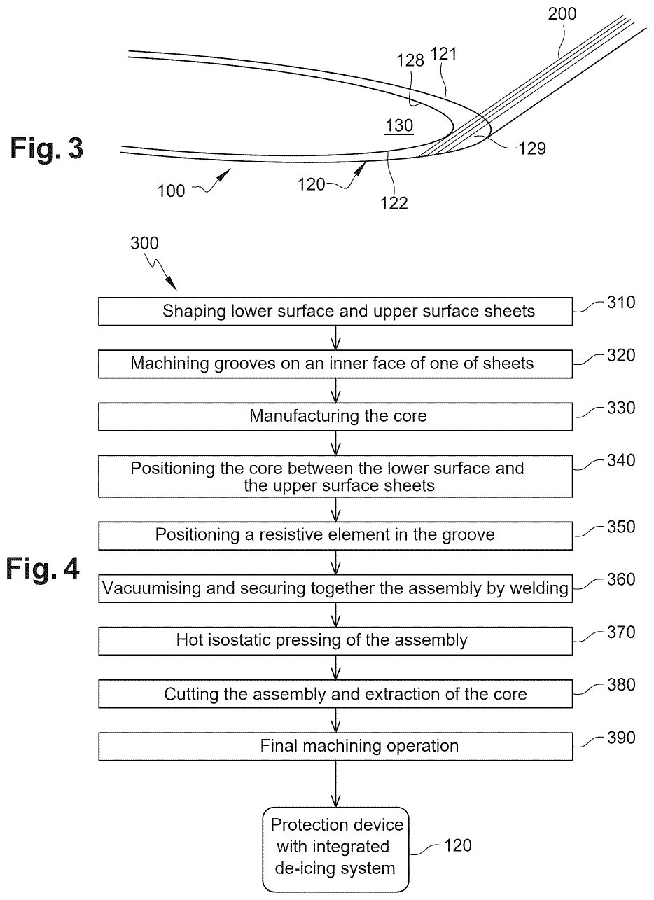

One example of a metal protection device according to the invention, adapted to protect the leading edge of a composite material blade, is represented in FIG. 3. This metal protection device 120 is designed both to wrap the leading edge 130 of the composite material blade (hereinafter referred to as the ‘composite material leading edge’) and to integrate an electrothermal type de-icing system 200. Once mounted, the metal protection device 120, together with the composite material leading edge 130, forms the leading edge of the blade 100.

FIG. 3 therefore shows the protection device 120 according to the invention, mounted to the composite material leading edge 130. This protection device 120 is a metal piece in which is housed a de-icing system 200 which extends along the composite material leading edge 130.

The metal protection device 120 according to the invention is partly formed by following the manufacturing method disclosed in patent FR2957545 filed on behalf of the applicant. The method disclosed in this patent uses a technique known as ‘on-core shaping’ for simultaneously manufacturing two metal protection devices 120, especially in order to reduce manufacturing costs.

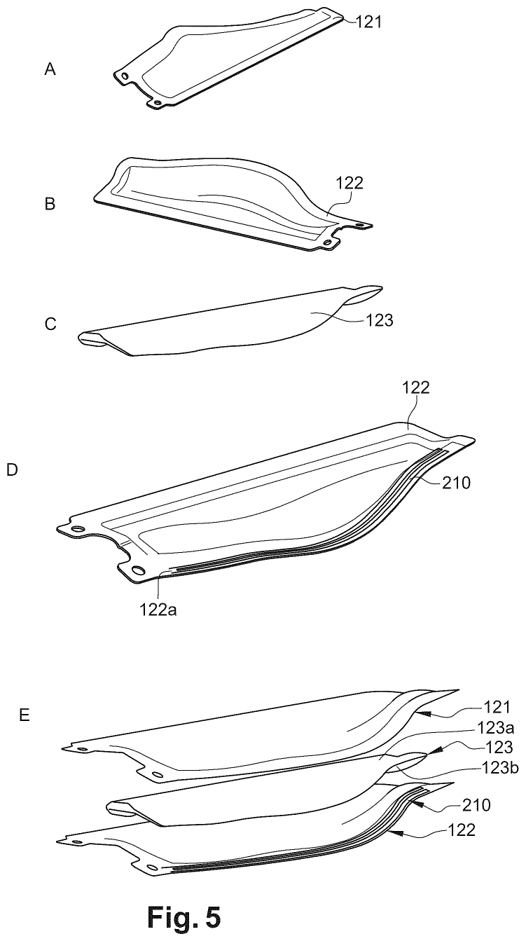

The method according to the invention, referenced 300, integrates the installation of a de-icing system during the operations of the on-core shaping method. This method according to the invention will be described with reference to FIG. 4, which represents the different steps in the method in functional form, and FIG. 5, which represents the various pieces used to implement the method.

This method 300 includes first of all an operation 310 of shaping a lower surface sheet 122 and an upper surface sheet 121. This shaping of the lower surface sheet 122 and upper surface sheet 121 is carried out by die forging in order to preform said sheets so that their shapes approximate the shape of the lower surface and upper surface, respectively, of the leading edge of the blade. An example of an upper surface sheet 121, after shaping, is represented in part A of FIG. 5. An example of a lower surface sheet 122, after shaping, is represented in part B of FIG. 5. These lower and upper surface sheets can be, for example, made of a titanium-based alloy (for example TA6V) or stainless steel (for example 304L).

The method 300 then includes an operation 320 of machining at least one groove on at least one inner face of one of the upper surface 121 or lower surface 122 sheets. The groove or grooves are made in the surface of at least one of the lower surface and upper surface sheets, in a so-called welding zone. This welding zone, for example the zone 122a on part D of FIG. 5, is the diffusion zone of the two sheets, i.e. the zone by which the lower surface 121 and upper surface 122 sheets will be assembled together after the assembly operations described below. The number, profile and dimensions of the grooves are defined as a function of the surface density of the power that has to pass through the de-icing system. According to the embodiments, a single groove may suffice; preferably, several grooves are machined to form an array of grooves. As will be explained later, the number of grooves is advantageously even so that the resistive element to be inserted into the grooves can have an inlet and an outlet close to each other. Whatever their number, the grooves are machined so as to be more or less parallel to each other. In some embodiments, for example where the resistive element is of relatively large diameter, for example a diameter in the order of 1 to 5 mm, grooves may be machined in both the lower surface and upper surface sheets, the grooves in each sheet being designed to face each other when the two sheets are assembled.

The method 300 then includes an operation 330 of manufacturing a core 123 having a shape identical to the shape of the composite material leading edge 130. This core 123, for example of refractory nickel base alloy, includes a shape identical to the shape of the composite material leading edge 130. This core 123 is designed for making, in the metal protection device 120, an inner cavity 128 having a shape adapted to the external shape of the composite material leading edge 130. One of the faces of core 123, such as face 123a represented in drawing E of FIG. 5, reproduces the inner face of the upper surface of composite material leading edge 130, the other face, such as face 123b in drawing E of FIG. 5, reproduces the inner face of the lower surface of composite material leading edge 130. The two faces 123a, 123b meet at the tip of the core 123 in a radius reproducing the inner shape of the composite material leading edge 130.

The method 300 then includes an operation 340 of positioning the core 123 between the lower surface sheet 122 and the upper surface sheet 121 and an operation 350 of positioning the resistive element 210 in the groove of one of the sheets 121 or 122. The resistive element 210 can, for example, be a thermally conductive wire or cable, which extends along the entire length of each of the grooves, looping back at the end of each groove to extend again into the next groove. In one example, the resistive element 210 is a heating cable made of copper and mineral insulator, installed in the grooves of the lower metal sheet, i.e. the metal sheet positioned below the core 123 (for example the lower surface sheet 122 in the example in FIG. 5). The operations 340 and 350 of positioning the core 123 and the resistive element 210 can be carried out in a predefined order (for example, positioning the resistive element before positioning the core or vice versa), the order of positioning depending, for example, on the choice of the sheet 121 or 122 including the grooves. After the resistive element 210 has been positioned in the grooves of one of the metal sheets (for example the lower surface sheet 122 in the case of FIG. 5) and the core 123 has been positioned above said sheet, the other sheet (for example the upper surface sheet 121 in the case of FIG. 5) is placed above the core 123.

The method 300 then includes an operation 360 of vacuumising and securing together the assembly formed by the core 123, the lower surface 122 and upper surface 121 sheets and the resistive element 210. This securing of the assembly ensures that it is sealingly closed. It can be achieved by welding—for example electron beam (EB) welding—of the weld zone of the two lower surface 122 and upper surface 121, said weld zone extending over the entire periphery of the two sheets. For this, an uninterrupted weld bead can be laid beforehand along the lateral edges of the lower surface and upper surface sheets as well as on their transverse edges, so that the core 123 is completely surrounded. Indeed, the lower surface 122 and upper surface 121 sheets should be sealingly assembled so that, during the subsequent compaction operation, the gas which exerts pressure on the assembly to ‘shape’ the sheets does not penetrate said assembly (if the gas penetrated inside the assembly, there would be an equi-pressure between inside and outside of the assembly, which would prevent the sheets from forming on the core as well as diffusion welding of the sheets together in the contact zones and especially at the nose of the protection device). It is also necessary for the air inside the assembly to be discharged, especially in the case of titanium sheets, because during the temperature rise of the assembly (during the compaction operation), the residual internal air will react with titanium, contaminating the surfaces and damaging welding in zones in contact between the sheets and especially the nose of the protection device. Electron beam welding, which is carried out in a vacuum, has the advantage of combining vacuumising and sealing of the assembly in a single operation. One alternative could be to carry out two successive operations: a TIG (Tungsten Inert Gas) sheet assembly operation, which is an arc welding operation carried out under air, followed by a vacuumising operation, using a tube positioned during TIG welding and then squeezed when vacuumising is performed.

The method 300 then includes an operation 370 of assembling the assembly by hot isostatic pressing. This operation of isostatic pressing, or compaction, of the assembly makes it possible to consolidate securing of said assembly by diffusion welding of the lower surface 122 and upper surface 121 sheets in the zones where said lower surface 122 and upper surface 121 sheets are in contact. It also enables the lower surface and upper surface sheets 122 and 121 to be shaped around the core 123 so that the inner surface of the assembly formed by the two sheets 121, 122 joined together takes the shape of the core 123. The hot isostatic pressing operation 370 can, for example, be carried out at a temperature of about 940° C., in the case of TA6V titanium alloy sheets. Indeed, at this temperature, the metal is relatively soft and can flow under the action of the pressure (approximately 1000 bar) applied to it, both lower surface and upper surface sheets deforming to perfectly match the shape of the core 123 and eliminate residual spaces.

Thus, after this isostatic pressing operation 370, the lower surface sheet 122 and the upper surface sheet 121 match the shape of the core 123 and form a compacted assembly 125, such as that represented in FIG. 6. In other words, the compacted assembly 125 corresponds to all the parts of drawing E of FIG. 5, being welded and compressed. This compacted assembly 125 also corresponds to a protection device before final machining.

An operation 380 of cutting this compacted assembly 125, obtained at the end of operation 370, is then carried out to extract the core 123 therefrom. This operation 380 consists in cutting, along a longitudinal axis MM, the lower surface and upper surface sheets of the compacted assembly 125. The compacted assembly 125 can, for example, be cut by laser with removal of the excess part of the assembly. Once the compacted assembly 125 is cut, the core 123 can be extracted from said assembly by partially cutting the periphery of the core 123 and detaching the core and the sheets of the assembly. Once the core 123 is extracted, the protection device 120 is obtained.

Once the protection device is obtained, a final machining operation 390 is performed to complete the external profile of said protection device and obtain a protection device 120 with an integrated resistive element and the desired profile.

After the final machining operation 390, the ends of the resistive element 210 of the protection device 120 are ends opening only onto part of the leading edge, for example the lower part closest to the engine axis of the turbofan. The resistive element 210 can thus be connected by a suitable circuitry to an electrical source.

The protection device 120 obtained by the method 300 thus includes a de-icing system 200 integrated into the nose of the leading edge of the blade 100. The de-icing system extends, as shown in FIG. 3, along the nose of the composite material leading edge 130, in the tip 129 of the protection device 120, over substantially the entire width I of said protection device. In other words, the de-icing system 200, and in particular the resistive element 210, is housed inside the protection device 120 in the contact zone between the lower surface skin formed by the lower surface sheet 122 and the upper surface skin formed by the upper surface sheet 121. The heating elements of the de-icing system 200 are thus at the border of the inner cavity 128 of the protection device 120 intended to receive the composite material leading edge 130 and thus in the immediate vicinity of the composite material leading edge 130.

As mentioned previously, the de-icing system 200 should be sized as a function of the surface power density required (in the order of 1 to 10 W·cm⁻² for example). According to one example, the de-icing system 200 may include one or more resistive elements 210 which heat, by conduction, the surface to be de-iced of the blade 100 via the circulation of a direct current (Joules effect). The resistive element 210 can be deployed over the entire width I of the tip 129 of the protection device 120 or only over part of this width, the tip 129 of the protection device being the zone where the lower surface sheet 122 and the upper surface sheet 121 are in contact with each other. A single length of resistive element 210 or several lengths that form a spiral-shaped array can be installed. Preferably, the resistive element 210 forms at least one turn, i.e. it includes at least one round trip, so that its two ends are located on the same end of the protection device 120, preferably the end closest to the base of the blade in order to facilitate the electrical connection thereof.

Resistive elements, such as the resistive element 210 shown in FIG. 5, preferably satisfy several conditions. Indeed, in addition to the resistive qualities specific to heat transfer, the material or materials constituting the resistive element should:
Have a melting point above 1050° C. and no phase change in the interval [20° C.-1050° C.] so that its resistive properties are not impaired. Indeed, in the on-core shaping phase, operation 370 of hot isostatic pressing is carried out at temperatures in the order of 850° C. to 1000° C. for a titanium metal protection device and at temperatures in the order of 950° C. to 1050° C. for a stainless steel metal protection device. The material or materials constituting the resistive element should remain in a solid state throughout the manufacturing cycle.
The material constituting the outer envelope of the resistive element should be as inert as possible, at isostatic pressing temperatures, with respect to the metal material of the lower surface and upper surface sheets (for example of TA6V or 304L stainless steel). Indeed, heavy local contamination of the metal material of the protection device could lead to excessive mechanical worsening on said material, and become prohibitive.
Advantageously, the resistive element should have a thermal expansion close to the metal alloys of the protection device (in the order of 10×10⁻⁰⁶ for titanium and 17×10⁻⁰⁶ for stainless steel) so that contact is as good as possible between said resistive element and the material of the metal protection device. Indeed, at the hot isostatic pressing temperature, the external skins of the material of the protection device-i.e. the lower surface skin and the upper surface skin-and the resistive element are in perfect contact but, during cooling, if the coefficient of expansion of the resistive element is much greater than the material of the metal protection device, the two materials may separate and a vacuum may be created between them on return to ambient temperature, which would reduce heat conduction between said resistive element and said protection device during operation.

For example, in the case of a protection device made of a titanium-based alloy, for example TA6V, or of a stainless steel alloy, for example 304L, the resistive element may mainly consist of a nickel-chromium alloy: such a nickel-chromium alloy remains in the solid state up to 1400° C. and its coefficient of thermal expansion is in the order of 15×10⁻⁰⁶.

When the resistive element is a heating cable, the latter may include a mineral insulator surrounding a thermally conductive wire made of a highly resistant metal, such as nickel-chromium, which converts electrical energy into heat. The thermally conductive wire, or conductive wire, can also be insulated with high grade magnesium oxide and then covered with a conventional corrosion resistant sheath material such as inconel 600, stainless alloy or stainless steel. In the case of a stainless steel protection device, the outer sheath of the resistive element can be of stainless steel. In the case of a titanium protection device, the outer sheath of the resistive element may be made of a titanium alloy. The alloys in contact during isostatic pressing are then fully compatible. The presence of a layer of magnesium oxide, or another insulating element, between the conductive wire and the outer sheath of the heating cable, makes it malleable when cold, which makes it easy to install said heating cable in the grooves machined on the lower surface and/or upper surface sheets.

Although described through a number of examples, variants and embodiments, the protection device according to the invention and its manufacturing method comprise various variants, modifications and improvements which will be obvious to the person skilled in the art, it being understood that these variants, modifications and improvements are within the scope of the invention.

1. A method for manufacturing a metal protection device for a leading edge of a composite material blade for a turbofan, the method comprising:
a) shaping by die forging, a lower face sheet and an upper face sheet
b) making a core having a shape identical to the shape of the leading edge of the blade,
c) positioning the core between the lower surface and upper surface sheets,
d) vacuumising and sealing the assembly by welding,
e) assembling the assembly by hot isostatic pressing,
f)_cutting the assembly and extracting the core,
g) final machining to obtain a protection device with a predefined profile, wherein:
on the one hand, operation a) includes machining, on an inner face of at least one of the lower surface and upper surface sheets, at least one groove adapted to receive a resistive element, and
on the other hand, operation c) includes positioning the resistive element in the groove, the resistive element forming an electrothermal heater integrated into the metal protection device of the leading edge of the blade.

2. The method according to claim 1, wherein operation a) includes machining an array of grooves including an even number of grooves.

3. The method according to claim 1, wherein the groove is machined in a welding zone of the lower surface or upper surface sheet, over at least part of the width of the protection device.

4. The method according to claim 1, wherein the resistive element is a heating cable including at least one thermally conductive wire made of metal, housed in an insulating sheath.

5. The method according to claim 4, wherein the thermally conductive wire is made of a nickel-chromium alloy.

6. The method according to claim 4, wherein the insulating sheath is made of a substantially inert material having a melting point above 1050° C. and no phase change in an interval between 20° C. and 1050° C. and having a thermal expansion close to a material from which the lower surface and upper surface sheets are formed.

7. The method according to claim 4, wherein the insulating sheath is at least partly made of a corrosion-resistant material.

8. The method according to claim 7, wherein the corrosion-resistant material is a titanium alloy or stainless steel.

9. The method according to claim 4, in wherein the heating cable includes a layer of magnesium oxide positioned between the thermally conductive wire and the insulating sheath.

10. A metal protection device for a leading edge of a composite material blade for a turbofan, comprising:
an upper surface sheet and a lower surface sheet assembled together and forming an inner cavity adapted to wrap the leading edge of the blade, and
a resistive element integrated into an inner face of at least one of the lower surface and upper surface sheets and forming an electrothermal heater integrated into the metal protection device of the leading edge of the blade.

11. The protection device according to claim 10, wherein the resistive element is housed in a contact zone between the lower surface sheet and the upper surface sheet, in a tip of said protection device.

12. A turbofan blade comprising a composite material leading edge and a metal protection device wrapping said leading edge, wherein the protection device includes a tip in which a resistive element is housed, said resistive element extending along the composite material leading edge.

13. A turbofan, comprising a plurality of blades according to claim 12.
